(19) United States
(12) Patent Application Publication
(10) Pub. No.: US 2009/0250914 A1
(43) Pub. Date: Oct. 8, 2009

(54) Module housing inflator flange

(75) Inventors: John Kemp, Murray, UT (US); Kelly Ellis, Rigby, ID (US); Gary Hampel, Ogden, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 12/080,541

(22) Filed: Apr. 2, 2008

(51) Int. Cl. B60R 21/26

(52) U.S. Cl. 280/741

(57) ABSTRACT

A fastener-less inflator apparatus may be used with an airbag. This apparatus includes an inflator. The inflator has a cap, a body, and a lip. An encompassing filter is also used. The filter may circumscribe the body of the inflator. Neither the inflator nor the encompassing filter has an inflator flange that anchors the inflator. The apparatus also includes a module housing. The module housing includes an opening, wherein the inflator and the encompassing filter are tightly fit into the opening.

### BACKGROUND OF THE INVENTION

Airbags and airbag systems have been known and used on motor vehicles. These systems are designed such that, in the event of an accident, the airbag will inflate and become positioned in the vehicle interior. This inflated airbag will protect the vehicle occupant and prevent the occupant from harmful impact with the steering wheel, dashboard, or other portions of the vehicle interior.

In order to properly function, the airbag system must include an inflator (which is sometimes called the “gas generator”). The inflator is designed to create and/or channel a large quantity of inflation gas into the airbag during a crash/accident. Such an influx of gas causes the airbag to inflate and deploy into the vehicle interior.

Inflators are generally cylindrical in shape so that it can fit within the steering wheel, the dashboard, etc. However, many inflators, especially for steering wheel airbag systems, include an inflator flange. The flange is a square or rectangular plate that is positioned along the longitudinal length of the cylindrical inflator. The flange extends outwardly from the inflator. The flange allows the inflator to be mounted to the airbag system. Specifically, the flange will include one or more fastener holes proximate the corners of the flange. Through these holes, fasteners may be passed to secure the inflator to the airbag module housing and/or the vehicle frame.

FIG. 1 illustrates a prior art representation of an inflator 2 having an inflator flange 3. As can be seen in FIG. 1, the inflator flange 3 is a rectangular or square piece that is attached to the cylindrical inflator 2. One or more fasteners 5 may be passed through holes 4 on the flange 3 and used to secure the inflator 2 to the vehicle structure (not shown). The way in which the inflator 2 may be secured to the vehicle structure is conventional and may be accomplished in a variety of different ways.

An airbag 6 may also be used in conjunction with the inflator 2. The airbag 6 is representative of any type of airbag that may be used. Likewise, the airbag 6 may be attached and/or secured to the inflator 2 such that when the inflator 2 produces inflation gas, the gas will exit the ports 7 and will enter the airbag 6, thereby inflating the airbag 6. The way in which the airbag 6 may be secured/attached to the inflator 2 and/or the vehicle structure is conventional. Any one of a variety of known methods may be used. Accordingly, as this technology is conventional, a detailed description of how the airbag 6 may be secured to the inflator 2 will not be provided.

Clearly, the flange 3 facilitates the mounting and securing of the inflator 2 to the airbag system. However, the inflator flange 3 increases the cost of the inflator 2. Accordingly, it would be less expensive if a new steering wheel airbag system could be designed in which the inflator did not require the use of an inflator flange. Such a system is disclosed herein.

### BRIEF SUMMARY OF THE INVENTION

A fastener-less inflator apparatus for use with an airbag is disclosed. The apparatus comprises an inflator. The inflator comprises a cap, a body, and a lip. The apparatus also comprises an encompassing filter, wherein neither the inflator nor the encompassing filter has an inflator flange that anchors the inflator. The apparatus also comprises a module housing comprising an opening, wherein the inflator and the encompassing filter are tightly fit into the opening. In some embodiments, the opening is circular and the filter is separate from the inflator. In some embodiments, the airbag may be attached to the module housing. Further embodiments are designed in which the module housing further comprises hooks configured to engage an airbag cover for defining an enclosure that houses an airbag.

In some embodiments, the module housing comprises a shelf that is proximate the opening, wherein the encompassing filter rests against the shelf. In other embodiments, a collar is added to the module housing. The collar engages the lip of the inflator. The body (of the inflator) may have exit holes positioned adjacent to the collar. When the apparatus deploys, gas exits the exit holes and is directed through the filter.

The present embodiments also teach a method for securing an inflator to a module housing. This method comprises the step of obtaining the inflator, wherein the inflator comprises a cap, a body, and a lip. The method also involves obtaining the module housing, wherein the module housing comprises an opening. The method also includes the step of obtaining an encompassing filter, wherein neither the inflator nor the encompassing filter has an inflator flange that anchors the inflator. The step of circumscribing the body of the inflator with the filter is also performed. Also the step of tightly fitting the inflator and the encompassing filter into the opening is accomplished. In some embodiments, the inflator and the encompassing filter are snap-fit into the opening.

The present embodiments relate to a new type of airbag system that does not require the inflator to include an inflator flange. Rather, in these embodiments, the inflator will be a cylindrical or disk-shaped member. In order to secure the inflator to the airbag system, the airbag system may include a module housing. This module housing will include an opening. The inflator is designed such that it may fit into the opening. More specifically, the inflator may be tightly fit (such as snap-fit, press-fit, crimped, etc.) within the opening. By having the inflator be crimped within the opening, the inflator is secured to the module housing and will not be able to move and will not become separated during deployment. Other embodiments may be designed in which the inflator is crimped or otherwise fastened into the opening.

In the present embodiments, the airbag system may further include an encompassing filter (which, for brevity may be referred to as the “filter”). The filter is used in conjunction with the inflator. The filter is designed to filter the gas as it exits the inflator. The filter may be a separate component from the inflator. However, in other embodiments, the filter may be part of and/or a component of the inflator.

The filter may be designed such that it circumscribes and/or surrounds the inflator. The filter may also be designed such that it is likewise tightly fit within the opening in the module housing. By having the filter be crimped within the opening, the filter is secured to the module housing and will not be able to move and will not become separated during deployment.

In order to properly retain filter, a shelf may be added proximate the opening. The shelf is designed to engage the filter such that the filter is positioned against the shelf. Such engagement holds the filter in the proper location. Likewise, embodiments may be constructed in which a collar is also added to the module housing. The collar engages the inflator and holds the inflator in the proper configuration.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a representation of a prior art system having an inflator and an airbag;

FIG. 2 is an exploded view of an apparatus according to the present embodiments;

FIG. 3 is a perspective view of the apparatus of FIG. 2;

FIG. 4 is a partial cross-sectional view of the embodiment of FIG. 2; and

FIGS. 5-7 are partial cross-sectional views similar to FIG. 4 which represent different methods for attaching an airbag to the apparatus.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

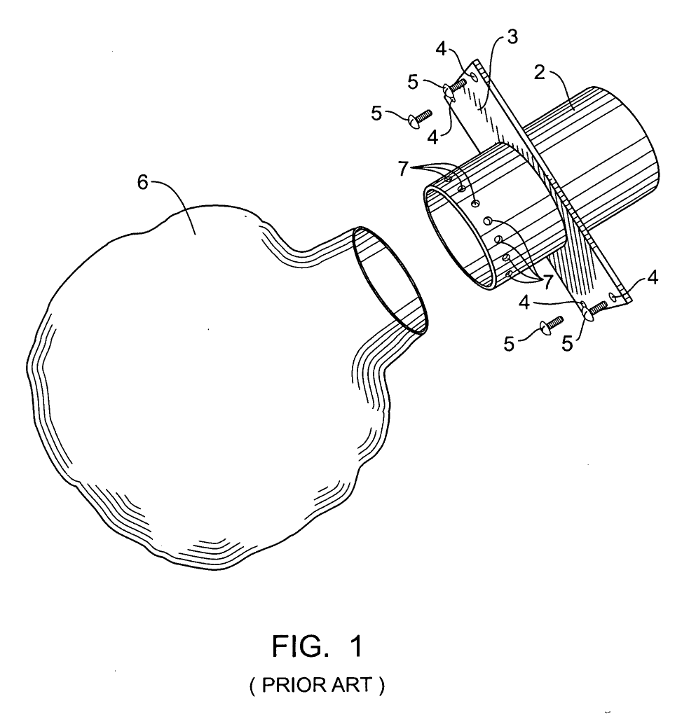

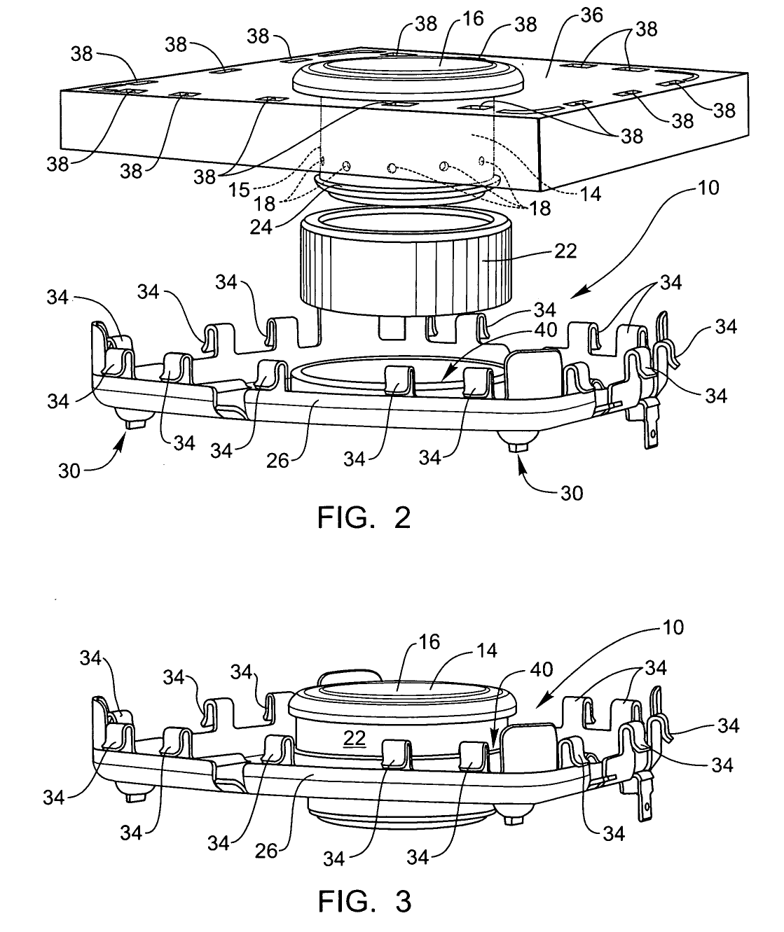

Referring now to FIG. 2, an exploded view of an fastener-less inflator apparatus 10 according to the present embodiments is illustrated. This apparatus 10 includes an inflator 14 that may be used to inflate and deploy an airbag 6 (shown in FIG. 1). The inflator 14 is designed to produce and/or channel a large quantity of inflation gas sufficient to inflate the airbag during an accident. As can be seen in FIG. 2, the inflator 14 does not have an inflator flange 3 or other type of similar feature. (The inflator flange was illustrated in the prior art depiction.) As described above, an inflator flange 3 is a square or rectangular piece added to an inflator that is designed to secure the inflator to the vehicle structure by having one or more fasteners pass through openings in the flange. As shown in FIG. 2, this type of inflator flange is not present in the inflator 14.

In the embodiment, the inflator 14 may include a body 15 and a cap 16. The cap 16 is positioned at the top of the inflator 14. The body may be cylindrical, thereby giving the inflator 14 its cylindrical shape. The cap may overhang the body 16 (as will be described in greater detail herein). The inflator 14 may have one or more gas exit holes 18 through which the inflation gas will pass during deployment. The exit holes may be added to the body 15. Gas is formed in the interior of the inflator 14 and then is allowed to exit the inflator 14 via the holes 18. Once the gas has exited the holes 18, the gas is channeled into the airbag.

An encompassing filter 22 (which may be referred to as simply a “filter”) may also be added to the apparatus 10. The filter 22 is designed to filter and/or strain the gas as the gas exits the holes 18. The purpose of the filter 22 is to cool the inflation gas and/or to remove any particulates and prevent such particulates from entering/accessing the airbag. As shown in FIG. 2, the filter 22 is an element that is separate from the inflator 14. More specifically, the filter 22 is a circular filter that is designed to surround and/or circumscribe all or a portion of the inflator 14. However, other configurations and/or shapes for the filter 22 may also be used. Similarly, other embodiments may also be designed in which the filter 22 constitutes a portion of the inflator 14. In these embodiments, the filter 22 may not be an element that is separate from the inflator 14.

The inflator 14 may further include a lip 24. The lip 24 is an optional feature. The lip 24 is a bump or extension that protrudes outward from the body. The lip 24 may be positioned proximate the bottom of the inflator 14. Other positions for the lip 24 may also be used.

The apparatus 10 may also include an airbag module housing 26. The module housing 26 is designed such that it may be mounted to a vehicle structure/frame (not shown). In order to facilitate such mounting, the airbag housing module 26 may include one or more fastener openings 30 that are designed to receive fasteners (not shown). When passed through the openings 30, the fasteners may operate to secure the module housing (and the entire airbag apparatus 10) to the vehicle structure.

As is known in the art, the module housing 26 may include one or more hooks 34. The hooks 34 are designed to attach to an airbag cover 36. The hooks 34 protrude through corresponding openings 38 in the cover 36 to secure the cover 36. When the airbag cover is attached, an enclosure (space) is formed between the cover 36 and the housing 26. The airbag 6 will be positioned within this space. As is known in the art, the airbag will deploy through the cover in the event of an accident to access and become positioned within the vehicle interior. In some embodiments, the top surface of the cover may be a “Class A” surface that is visible to the occupant and is visually appealing and/or will match the overall decor of the vehicle interior.

The module housing 26 may also include an opening 40 that is designed to receive both the filter 22 and the inflator 14. As is described in greater detail herein, the module housing 26 is designed such that the filter 22 and/or the inflator 14 may be tightly fit (such as snap-fit, press fit, crimped, etc.) into the opening 40. This crimping or press fitting means that the inflator 14 and/or the filter 22 are tightly secured to the module housing 26 without the use of an inflator flange, any fasteners, etc.

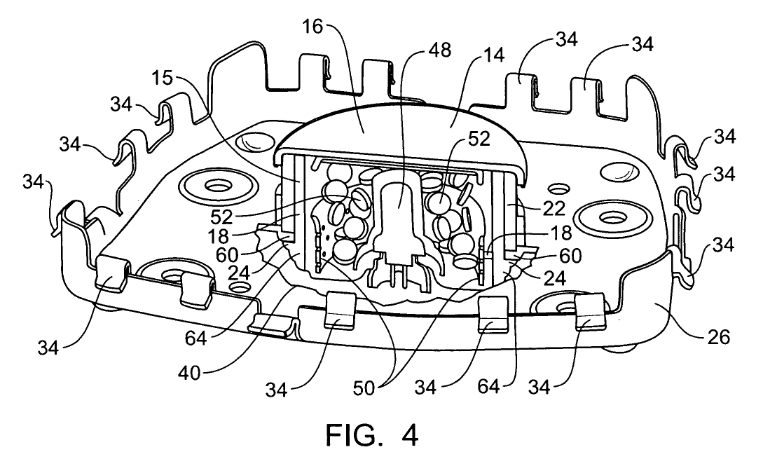

Referring now to FIG. 3, an assembled view of the apparatus 10 is illustrated. As can be seen in FIG. 3, the filter 22 and/or the inflator 14 are designed to be crimped or tightly fit into the opening 40, thereby making a compact system. When the cover (not shown) is then added, there will be sufficient space to store an airbag that may ultimately be deployed in the event of an accident or crash.

As shown in FIG. 3, the bottom end of the inflator 14 may protrude through the opening 40. In other words, the inflator 14 is sufficiently long such that the end of the inflator 14 may pass completely through the opening 40. However, it should be noted that the lip 24 (shown in FIG. 2) will engage the inner surface of the opening to tightly hold the inflator 14 within the opening 40.

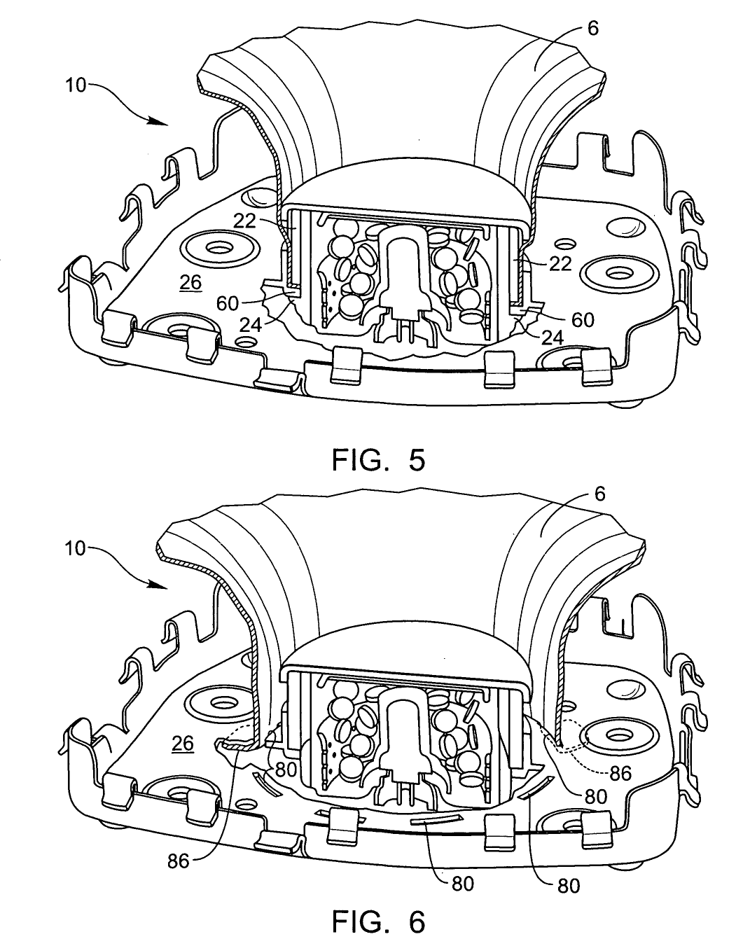

FIG. 4 is a perspective view of the apparatus of FIG. 2 in which a partial cross-section of the inflator 14 has been taken for clarity. This partial cross-sectional view of the inflator 14 illustrates that the inflator 14 may include an initiator 48 and a quantity of gas generant 52. As is known in the art, in the event of an accident or crash, the initiator 52 will ignite the gas generant 52, which in turn will produce the quantity of inflation gas that may be used to deploy the airbag. The gas will flow through a diffuser 50 and then exit the inflator 14 via the openings 18. Once it passes through the openings 18, the gas will pass through the filter 22 prior to entering the airbag. Those skilled in the art will appreciate how such ignition of the generant 52 may be accomplished.

By taking the cross-section of the inflator 14, the opening 40 is also visible. As can be seen in FIG. 4, the filter 22 and the inflator 14 are tightly fit (crimped) into the opening 40. The module housing 26 may further be designed to include features that engage the inflator 14 and/or the filter 22. For example, the module housing 26 may include a shelf 60 that is designed to engage and/or receive the filter 22. This shelf 60 is positioned within and/or proximate the opening 40. Thus, when properly positioned, the bottom of the filter 22 will rest and/or be positioned against the shelf 60.

Similarly, the module housing 26 may also include a collar 64 that extends downward past the shelf 60. This collar 64 is designed to engage and/or receive inflator 14. This collar 64 is positioned within and/or proximate the opening 40. (As can be seen in FIG. 4, the collar 64 is positioned proximate the exit holes 18). When properly positioned, the lip 24 of the inflator 14 engages the collar 64 to ensure that the inflator 14 is tightly fit. Similarly, when tightly fit, the filter 22 is between the cap 16 and the lip 24—i.e., surrounding the body 15.

It should be noted that any type of tight fit—e.g., a fit capable of restraining the inflator 14—may be used. For example, embodiments may be constructed in which housing 26 includes a knob or feature that engages and/or fits into a cleft on the inflator 14. Other types of engagement are also possible.

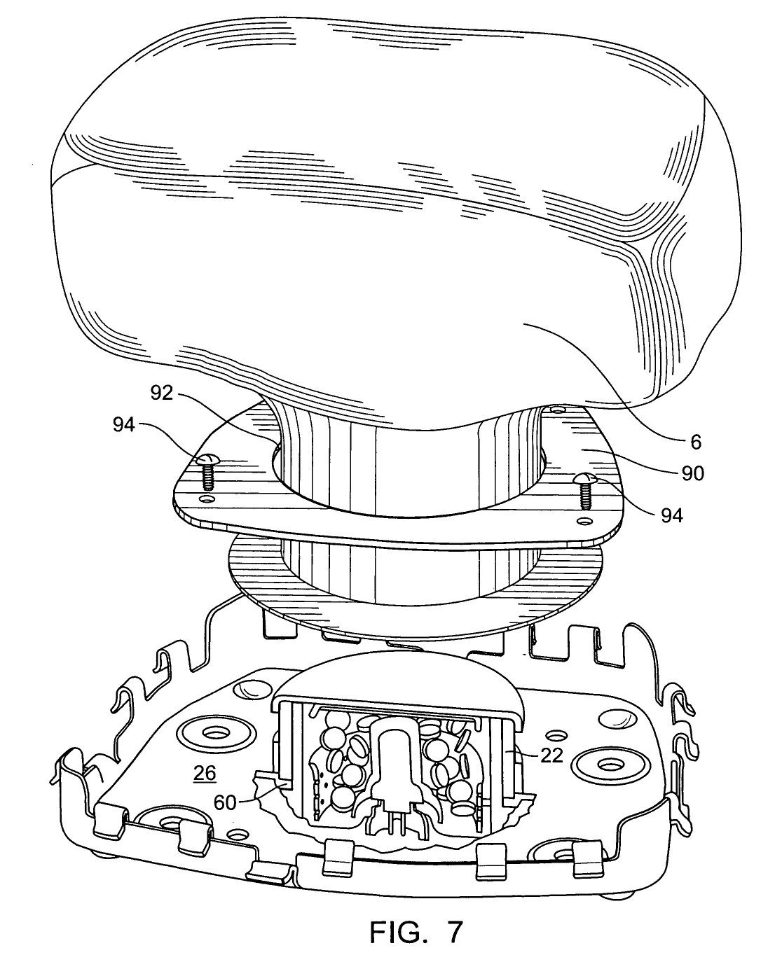

It should be noted that a variety of different methods may be used to attach the airbag 6 to the airbag apparatus 10. In fact, any number of known methods may be used to attach the airbag. FIG. 5 gives a first example of the way in which the airbag 6 may be attached to the apparatus 10. For example, a portion of the airbag 6 may be placed (i.e., crimped, press-fit, etc.) between the filter 22 and the module housing 26 (or more specifically the shelf 60) and thus be “sandwiched” as part of the crimp. In this embodiment, the crimp operates to attach and secure the airbag in its proper configuration without the need for separate fasteners.

FIG. 6 represents another embodiment of the way in which the airbag 6 may be attached to the module housing 26. (It should be noted that the airbag 6 may be attached in a variety of different ways, such as rivets, hooks, snaps, plates, or other methods currently in use.) In FIG. 6, slot(s) 80 are cut into the module housing 26. The airbag (or a portion of the airbag) could then be pulled through the slots 80. Specifically, the airbag 6 includes tabs 86 that may be folded over (such as folded over the slots 80) to prevent the airbag from retracting out of the slots 80. One or more fasteners (not shown) may also be used to further restrain the tabs 86. Such engagement between the slot(s) 80 and the tab 86 and/or airbag 6 may be secured/attached. This embodiment uses an airbag retainer 90 that engages the airbag 6. Specifically, a portion of the airbag 6 will pass through an opening 92 in the retainer 90. Once passed through, fasteners 94 may pass through the retainer 90 and the airbag 6 to engage/secure the airbag 6. This type of airbag retainer is known in the art and allows the airbag to be bolted, riveted, TOXed, or otherwise fastened in place after the airbag has been properly positioned.

Referring now to all of the Figures, a skilled artisan would also appreciate that a method for securing an inflator 14 to a module housing 26 may be accomplished. This method involves obtaining the inflator 14 and obtaining the module housing 26. As noted above, the inflator comprises the body 15, the cap 16, and the lip 24, whereas the housing comprises the opening 40. The encompassing filter 22 will also be obtained. It should be noted that neither the inflator 14 nor the encompassing filter 22 has an inflator flange 3 that anchors the inflator 14. The method also includes the step of circumscribing the body 15 of the inflator 14 with the filter 24. Further, the method may involve tightly fitting the inflator 14 and the encompassing filter 22 into the opening 40. In some embodiments, this may involve snap-fitting the inflator 14 and the filter 22 into the opening 40.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A fastener-less inflator apparatus for use with an airbag comprising:
an inflator comprising a cap, a body, and a lip;
an encompassing filter, wherein neither the inflator nor the encompassing filter has an inflator flange that anchors the inflator; and
a module housing comprising an opening, wherein the inflator and the encompassing filter are tightly fit into the opening.

2. An apparatus as in claim 1 wherein the encompassing filter circumscribes the inflator.

3. An apparatus as in claim 1 wherein the filter is separate from the inflator.

4. An apparatus as in claim 1 wherein the opening is circular.

5. An apparatus as in claim 1 wherein the module housing comprises a shelf that is proximate the opening, wherein the encompassing filter rests against the shelf.

6. An apparatus as in claim 5 further comprising a collar that engages the lip of the inflator.

7. An apparatus as in claim 1 wherein the module housing may further comprise hooks configured to engage an airbag cover for defining an enclosure that houses an airbag.

8. An apparatus as in claim 1 wherein the airbag may be attached to the module housing.

9. An apparatus as in claim 1 wherein the body has exit holes positioned adjacent to the collar.

10. An apparatus as in claim 9 wherein when the apparatus deploys, gas exists the exit holes and is directed through the filter.

11. A method for securing an inflator to a module housing comprising:
obtaining the inflator, wherein the inflator comprises a cap, a body, and a lip;
obtaining the module housing, wherein the module housing comprises an opening;
obtaining a encompassing filter, wherein neither the inflator nor the encompassing filter has an inflator flange that anchors the inflator;
circumscribing the body of the inflator with the filter; and
tightly fitting the inflator and the encompassing filter into the opening.

12. A method as in claim 11 wherein the inflator and the encompassing filter are snap-fit, crimped or otherwise fastened into the opening.

13. A method as in claim 11, wherein the module housing comprises a shelf that is proximate the opening, wherein the encompassing filter rests against the shelf.

14. A method as in claim 13, further comprising a collar that engages the lip of the inflator.
